(19) United States
(12) Patent Application Publication
(10) Pub. No.: US 2008/0224462 A1
(43) Pub. Date: Sep. 18, 2008

(54) Transparent tamper-indicating data sheet

(76) Inventors: Andrew D. Dubner, St. Paul, MN (US); Brian W. Dunne, Cambridge Park (AU); James M. Jonza, Woodbury, MN (US); Lynn E. Lorimor, Minneapolis, MN (US); Graeme R. Mann, Sussex Inlet (AU); Shivshankar Venkataramani, Eagan, MN (US)

Correspondence Address: 3M INNOVATIVE PROPERTIES COMPANY, PO BOX 33427, ST. PAUL, MN, 55133-3427, US

(21) Appl. No.: 11/437,962

(22) Filed: May 19, 2006

Related U.S. Application Data
(63) Continuation-in-part of application No. 09/846,632, filed on May 1, 2001.

(51) Int. Cl. B42D 15/00; B42D 15/10

(52) U.S. Cl. 283/75; 283/107; 283/72

(57) ABSTRACT

A transparent tamper-indicating data sheet is provided wherein a transparent durable layer (a first major component), such as polyester or a multilayer optical film (MOF), is adhered to a fragile layer (a second major component), such as a holographic foil or a security laminate, such as Confirm™ Security Laminate, either the fragile sheet or film or the durable layer being printed with identification and/or verification information. The components of the transparent data sheet are laminated together with or without an adhesive layer between the two major components. The two major components have the same outside dimensions and are congruent. Evidence of tampering with the identification or verification information is easily viewed from either side of the transparent data sheet.

This application is a continuation-in-part of U.S. patent application Ser. No. 09/846,632 filed May 1, 2001, the contents of which are incorporated herein by reference in their entirety.

### TECHNICAL FIELD

This disclosure pertains to a tamper-indicating transparent data sheet using at least a single layer of a fragile material and a layer of durable material, or at least two layers of two different fragile materials, such that either combination of the two layers forms a durable sheet.

### BACKGROUND

Documents of value such as passports, identification cards, entry passes, ownership certificates, financial instruments, and the like, are often assigned to a particular person by personalization data. Personalization data, often present as printed images, can include photographs, signatures, fingerprints, personal alphanumeric information, and barcodes, and allows human or electronic verification that the person presenting the document for inspection is the person to whom the document is assigned. There is widespread concern that forgery techniques can be used to alter the personalization data on such a document, thus allowing non-authorized people to pass the inspection step and use the document in a fraudulent manner.

A number of security features have been developed to authenticate a document of value, thus preventing forgers from producing a document which resembles the authentic document during casual observation, but lacks the overt or covert security features known to be present in the authentic document. Overt security features include holograms and other diffractive optically variable images, embossed images, floating virtual images, and color-shifting materials, while covert security features include images only visible under certain conditions such as inspection under light of a certain wavelength, polarized light, or retroreflected light. Even more sophisticated systems require specialized electronic equipment to inspect the document and verify its authenticity. Often, these security features are directed at verifying the authenticity of the parent document, but convey little information regarding the authenticity of the personalization data. Further features that convey information about, or prevent, tampering with the personalization data are needed.

Tamper-indicating features that have been included in documents of value include encapsulation of the printed images between laminated layers, laminates which will show evidence of tampering, and cover layers which can not be removed without destroying the integrity of the layer which contains the printed image. Still, sophisticated forgers have found techniques to expose and alter the printed images that form the personalization data, especially where the reverse side of such data is hidden by an opaque layer such as security paper. There would be great utility in a document which includes tamper-indicating and authenticating security features. Particularly, such a document which allows easy inspection for tampering of both the front and reverse sides of the personalization data image would add a new level of security to prevent forgeries.

### SUMMARY

Briefly, in one aspect of the present disclosure, a transparent data sheet is provided wherein a transparent durable layer (a first major component), such as polyester or a multilayer optical film, is adhered to a fragile layer (a second major component), such as a holographic foil or a security laminate, such as 3M™ Confirm™ Security Laminate from 3M Company of St. Paul, Minn., either the fragile layer or the durable layer being printed with identification and/or verification information (i.e., personalization data). As used herein, “personalization data” can include printed images, photographs, signatures, fingerprints, personal alphanumeric information, and/or barcodes, among other things, and allows human or electronic verification that the person presenting the document for inspection is the person to whom the document is assigned. The components of the transparent data sheet are laminated together with or without an adhesive layer between the two major components, such that the printed information and/or image is protected by the two components. The two major components can have the same outside dimensions and can be congruent.

The term “fragile” layer, as used herein, describes a film or material that is mechanically weak, as compared to the durable layer, and is typically constructed with a removable carrier layer for ease of handling or stability for printing. The fragile layer may contain various security features which can be visually authenticated. At least a portion of the fragile layer and/or one or more of its incorporated security features will be visibly damaged and/or destroyed if an attempt is made to alter the personalization data in the document. The term “durable” layer, as used herein, describes a film that is a free-standing film, without the necessity of a carrier layer, that can survive document-making process steps, such as being sewn into the spine of a passport book, as well as repeated handling, such as typical passport use. It is advantageous that the durable film be thermally stable to withstand laminating or other processing temperatures, typically in the range of 100 to 150° C. The term “transparent”, as used herein, describes a construction where either the personalization data can be observed from both sides of the data sheet or where security features that reside on any interior layer or on one side of the data sheet can be observed from the other side of the data sheet.

The durable layer may also contain various security features which can be visually authenticated. Furthermore, both the durable layer and the fragile layer can be constructed to have more than a single component or layer. Additionally, the durable layer could comprise a series of durable and fragile layers. For example, a durable layer could be configured to include a multilayer optical film, an adhesive layer and a second multilayer optical film, or a multilayer optical film and a layer of polyester film. Similarly, a fragile layer could be comprised of a holographic foil, a high refractive index layer, and a protective coating. These configurations are merely for illustration and should not be construed to limit the present disclosure.

According to one embodiment of the disclosure, a transparent data sheet is comprised of a multilayer optical film adhered to a fragile layer. Such multilayer optical films may also provide additional security features, such as clear to cyan color shifting multilayer optical film described in U.S. Pat. No. 6,045,894.

In another embodiment, the fragile layer can contain an ink-receptive layer so that the ink used to print the personalization data becomes a permanent part of the fragile layer by being absorbed by the ink-receptive layer. In this way, the data itself can be protected from tampering.

In another embodiment of the disclosure, a transparent data sheet is comprised of a first fragile layer adhered to a second fragile layer, wherein the laminate of the two fragile sheets is a durable sheet. Advantageously, such a construction could produce a transparent data sheet comprised of a holographic foil (a first fragile sheet) and a layer of glass beads embedded in a layer of beadbond, such as 3M™ Confirm™ Security Laminate (a second fragile sheet).

In the above embodiments, an optional thin layer of hot-melt adhesive can be used on either the durable or fragile layer. For example, a hot melt adhesive can be coated onto a holographic foil, the adhesive of which can be printed with the personalization data. Once printed, the holographic foil can be laminated at or above the melt temperature of the hot melt adhesive.

Alternatively, the two layers can be laminated together when one of the layers has a hot meltable surface, such as a multilayered film, wherein one of the surface layers is a low melting point thermoplastic.

Advantageously, the present disclosure provides a transparent data sheet that contains one or more security features, including but not limited to the destruction of the fragile layer indicating tampering or attempted delamination. Overt security features can include holograms and other diffractive optically variable images, embossed images, floating virtual images, and color-shifting materials, while covert security features include images only visible under certain conditions such as inspection under light of a certain wavelength, polarized light, or retroreflected light.

In yet another embodiment, a process of manufacturing a transparent data sheet is provided, comprising the steps of (1) printing identification information onto a surface of a first layer and (2) laminating this first layer, printed side to the inside to another film or layer, wherein both layers are optically transparent and one layer is more fragile than the other.

In still another embodiment, a process for manufacturing a transparent data sheet is provided, comprising the steps of (1) providing a printable surface of a first fragile layer, (2) providing a second layer, which is a durable layer or is a fragile layer, with the proviso that combination of the first and second layer provide a durable sheet, and (3) providing instructions for printing and assembling the transparent data sheet.

### BRIEF DESCRIPTION OF THE DRAWINGS

FIG. 1 is an end view of an embodiment of the present disclosure.

FIG. 2 is an end view of an alternative embodiment of the present disclosure.

FIG. 3 is an end view of an alternative embodiment of the present disclosure.

### DETAILED DESCRIPTION

### General Construction

A transparent data sheet is provided wherein a transparent durable layer (a first major component) is adhered to a fragile layer (a second major component), such as a holographic foil or a security laminate, such as Confirm™ Security Laminate, such that the fragile layer indicates tampering of the printed personalization data. The term “transparent”, as used herein, describes a construction where either the personalization data can be observed from both sides of the data sheet or where security features that reside on any interior layer or on one side of the data sheet can be observed from the other side of the data sheet. The components of the transparent data sheet can be laminated together with or without an adhesive layer between the two major components. Herein, the use of the term ‘major layer’ is interchangeable with the term ‘major component’.

In an alternative embodiment, a transparent data sheet is provided wherein the first major component is a second fragile layer, wherein the combination of the first and second major components forms a durable transparent sheet.

This construction may also include a tie layer for bonding the layers of the sheet together, a patterned coating layer with differential adhesion for providing an indication of tampering by delamination, and additional security features visible under various lighting conditions.

Furthermore, both the durable layer and the fragile layer can be comprised of more than a single component or layer. For example, a durable layer could be configured to include a multilayer optical film, an adhesive layer and a second multilayer optical film, or a multilayer optical film and a layer of polyester film. Similarly, a fragile layer could be comprised of a holographic foil, a high refractive index layer, and a protective coating. These configurations are merely for illustration and should not be construed to limit the present disclosure.

In addition, the transparent data sheet can include additional features that, when combined with features of other components of a document of value, become an additional security feature. For example, if the transparent data sheet contains a near infrared (IR) or ultraviolet (UV) light reflecting or absorbing component, then an IR or UV-responsive material behind the data sheet would not respond when viewed through the data sheet. Therefore, for example, if the data sheet were IR-reflecting or absorbing, black pigment printing on a page behind the data sheet, while visible in ambient light, would be invisible when viewed under IR lighting. Such features would help prevent simplistic emulation of the durable component.

One example of an IR-reflecting durable substrate is 3M™ Window Film, which contains a multilayer optical film that reflects light in the IR wavelength range. Alternatively, UV or IR absorbing additives may also be added to the fragile layer, the durable layer, or an adhesive between them. Such additives are known to those familiar with the art and include such materials as Irganox from Ciba Specialty Chemicals, Basal, Switzerland.

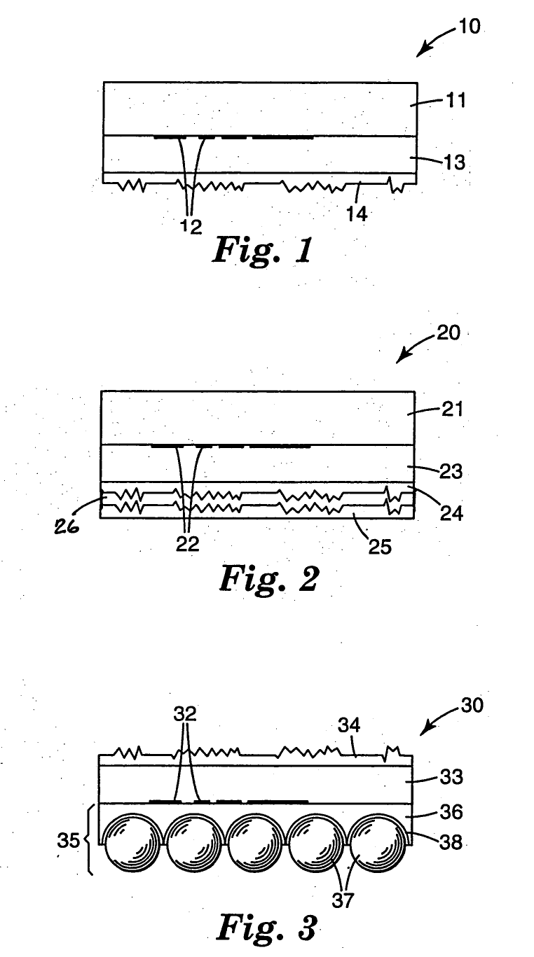

Referring now to FIG. 1, a transparent data sheet 10 according to the present disclosure is illustrated comprising a durable layer 11, printed indicia 12, an adhesive layer 13 and a holographic foil 14. Holographic foil 14 represents the fragile layer of the present disclosure. Although illustrated as a holographic foil, layer 14 also includes foil without a holographic structure, multilayer polyurethane films, glass beads in a beadbond layer, such as 3M™ Confirm™ Security Laminate or a film or material that is mechanically weak and is typically constructed with a removable carrier layer for ease of handling or stability for printing.

Referring now to FIG. 2, an alternative embodiment of the present disclosure is shown. A transparent sheet 20 is illustrated comprising a durable layer 21, printed indicia 22, an adhesive layer 23, a holographic foil 24, and a high refractive index coating 26. As stated above in reference to FIG. 1, the durable layer 21, and the holographic foil 24 can also be a combination of other films and/or coatings, for example a protective coating 25.

Referring now to FIG. 3, yet another alternative embodiment of the present disclosure is illustrated. A transparent sheet 30 is illustrated comprising a fragile film (identified as a holographic foil) 34, an adhesive layer 33, printed indicia 32 and a second fragile layer 35 comprised of glass beads 37, a reflective coating 38 and a beadbond layer 36. Additional security elements can be added to the second fragile layer 35 by adding printing on a predetermined array of glass beads 37, prior to the reflective coating 38.

### Fragile Materials or Layers

The term “fragile” layer, as used herein, describes a film or material that is mechanically weak and is typically constructed with a removable carrier layer for ease of handling or stability for printing. The fragile layer may contain various security features which can be visually authenticated. The fragile layer and/or one or more of its security features will be visibly damaged or destroyed if an attempt is made to alter the personalization data in the data sheet.

Such fragile layers include but are not limited to holographic foils of typical thickness from 1 to 5 microns, glass beads in a beadbond layer of typical thickness from 100 to 175 microns, optical stacks of typical thickness from 0.25 to 25 microns, and multilayered polyurethane films of typical thickness from 10 to 50 microns.

A holographic layer typically comprises two parts: a structured layer and an optional reflective layer. The structured layer can be formed by several methods that are well known in the art, as disclosed in U.S. Pat. No. 4,856,857 (Takeuchi et al.), the contents of which are incorporated herein by reference. It may be made of materials such as polymethyl methacrylate, nitrocellulose, and polystyrene. The structured layer includes a microstructured relief pattern of holographic or diffractive optically variable images in the form of logos or patterns that reflect or interfere with light. An embossed microstructured layer may be formed by contacting the material from which the structured layer will be made with a non-deformable embossing plate having a microstructured relief pattern, and applying heat and pressure to impart the microstructure. Alternatively, the structured layer may be made by other suitable processes, such as radiation curing, and may be made of materials such as urethane, epoxy, polyester, and acrylate monomers and oligomers, which are formulated with photoinitiators, cast on a non-deformable tool having a microstructured relief pattern, and radiation cured to form the microstructure in the material.

The optional reflective layer is coated on the structured layer either before or after embossing. The reflective layer has a refractive index differing from, and preferably higher than the structured layer. In a preferred embodiment, the reflective layer is substantially transparent and colorless. Illustrative examples of suitable reflective layer materials include but are not limited to bismuth trioxide, zinc sulfide, titanium dioxide, and zirconium oxide, which are described in U.S. Pat. No. 4,856,857 (Takeuchi et al.). Less transparent materials such as thin aluminum or silver, or patterned reflectors can also be used. The reflective layer enhances the reflection of light through the structured layer due to the difference in refractive index between the structured and reflective layers. Thus, the structured holographic pattern is more readily visible to the unaided eye once the reflective layer is coated on the structured layer, and an adhesive can be directly applied to the structured layer without diminishing the visibility of the structured pattern.

Retroreflective layers may comprise one or more types of retroreflective materials, including microsphere-type retroreflective materials and cube corner-type retroreflective materials. 3M™ Confirm™ Security Laminate is a preferred retroreflective layer, as disclosed in U.S. Pat. No. 3,801,183 (Sevelin et al.) and herein incorporated by reference, comprises an exposed monolayer of glass microspheres, indicia patterns printed on the back surface of the microspheres, a reflector layer on the back surface of the printed indicia and the glass microspheres, and a beadbond layer. The reflector layer is preferably transparent, high refractive index material. The authenticity of 3M™ Confirm™ Security Laminate can be verified when viewed under retroreflective lighting conditions.

In one embodiment, the use of a retroreflective glass bead layer such as 3M™ Confirm™ Security Laminate would allow the use of a floating virtual image security feature such as that described in U.S. Pat. No. 6,288,842. The fidelity of these floating images requires that the glass beads remain in the same relative position as when they were imaged. If the fragile layer is disturbed during an attempt at tampering which causes a shift in the relative location of the glass beads, the floating images would then provide an obvious indication of attempted tampering as the floating images would be distorted.

An alternate retroreflective layer, as disclosed in U.S. Pat. No. 2,407,680 (Palmquist et al.), may comprise an enclosed monolayer of glass microspheres, which are coated in a spacing resin comprising, for example, polyvinyl butyral or polyester. The spacing resin conforms to the microspheres. A reflector layer underlies spacing resin, and may comprise opaque materials such as silver, aluminum, chromium, nickel, or magnesium, or transparent high-index reflector materials such as those described above for use on the holographic structured layer, such as zinc sulfide, or multilayer reflectors as described in U.S. Pat. No. 3,700,305 (Bingham). Under retroreflective lighting conditions, light that enters the retroreflective layer is focused by the glass microspheres through the spacing resin and is reflected by the reflector layer back through the spacing resin and glass microspheres to an observer.

### Imaging of Personalization Data

According to additional embodiments, personalization data can be provided on (e.g., bonded to) the fragile layer. For example, the personalization data can be printed on either the exterior surface or on an interior surface of the fragile layer. Alternatively, if an adhesive is needed to bond the fragile layer to the durable layer, the data can be printed on either surface of the interior adhesive layer.

One way to image the data sheet with personalization data is to form an image on the exposed side of a hot-melt adhesive layer already attached to the fragile layer that is afterwards laminated to the durable layer. This image formation may be achieved by a number of techniques, such as printing. Furthermore, a hot-melt adhesive layer can be on either of the major layers and therefore the personalization data can be imaged onto either layer, prior to being sandwiched between the two major layers.

Suitable printing techniques can include those that employ dry toner, liquid toner, or ink-jet printing. Another technique employs a thermal mass transfer or thermal dye transfer donor element that may contain a pigment or dye and is positioned face-to-face with the hot-melt adhesive layer, whereupon a thermal print head can selectively apply heat from the back of the donor element to transfer color and binder to the hot-melt adhesive. This process can be repeated using additional colors to provide a three-color or four-color transfer image. For a discussion of a comparable thermal imaging process, see U.S. Pat. No. 3,898,086 (Franer et al.).

If the personalization data is printed on the hot-melt adhesive, preferred hot-melt adhesives are matched to the imaging technique to accept the imaging without subsequent blurring after lamination to the second layer. Furthermore, the hot melt adhesives useful in the present disclosure should form strong enough bonds between the two major layers that attempted delamination of the two major layers would destroy the fragile layer and effectively destroy the adhesive layer. As used in this application “effectively destroy” means that the adhesive layer cannot be re-used without evidence of tampering. Preferably, these hot melt adhesives are coated as a matte or textured layer, such that the micro-structured surface of these layers aids in the reduction of trapped air during a lamination process.

For inkjet printing, the hot-melt adhesive layer should include an ink-jet receptive layer. Such adhesives and ink-receptive layers are described in U.S. Ser. No. 09/591,592, filed Jun. 9, 2000, entitled “Inkjet Printable Media.”

For use with dry toner and thermal mass transfer imaging techniques, a preferred class of hot-melt adhesives that forms strong bonds is linear, random copolyesters of one or more aromatic dibasic acids and one or more aliphatic diols, modified with up to about 30 mole % of one or more aliphatic dibasic acids, as in U.S. Pat. No. 4,713,365 (Harrison). Among other useful classes of hot-melt adhesives are ethylene/vinyl acetate (EVA) copolymers, ethylene/acrylic acid (EAA) copolymers, ethylene/ethyl acrylate (EEA) copolymers, ethylene/methyl acrylate (EMA) copolymers, and polyethylene.

For a thermal dye transfer donor system, the glass transition temperature (Tg) of useful hot-melt adhesives should be from about −15° to about 150° C. At substantially lower Tg, there would be a danger of image blurring or image migration. At a Tg substantially higher than said preferred range, it would be necessary to employ undesirably high temperatures to laminate. Preferably, the Tg of the hot-melt adhesive is from about 40° C. to about 100° C.

The layer of hot-melt adhesive preferably is between about 15 to 100 microns in thickness when the document to which the overlay is to be applied is porous like paper. The layer of hot-melt adhesive preferably is between about 10 to 50 microns in thickness when the document to which the overlay is to be applied is smooth, e.g., a plastic film or plastic coated paper. Even when the document is smooth, the thickness of the hot-melt adhesive preferably is at least about 50 μm when one of the layers is a retroreflective layer of glass beads with a beadbond layer, and dye or pigment is used to form the image on the hot-melt adhesive layer. Substantially thinner layers might result in migration of the imaging dye from the hot-melt adhesive layer into the beadbond layer of the retroreflective sheeting. On the other hand, a thickness of the hot-melt adhesive exceeding about 200 μm facilitates tampering of the layers by peeling apart within the adhesive layer. Furthermore, it can be difficult to form uniform coatings of the hot-melt adhesive at substantially greater thicknesses.

One method of forming the data sheet of the present disclosure includes pre-attaching the durable layer into a document, such as a passport book and then printing on the exposed surface of the fragile material surface, a reverse image of the personalization data. The fragile layer can then be laminated to the durable layer within the passport book, thereby forming a transparent data sheet. If, subsequently, someone attempted to tamper or delaminate the data sheet to alter the data, the fragile portion of the laminate would indicate tampering.

In an additional embodiment, after lamination it may be useful to cross-link the adhesive to prevent tampering. Cross-linking the adhesive would make clean separation of the fragile and durable layers exceedingly difficult. Cross-linking can be achieved by chemical, thermal, or radiative means known to those familiar with the art.

Alternatively, the personalization data can be printed on the exposed surface of the fragile layer. For example, if the fragile layer is a glass-bead layer such as 3M™ Confirm™ Security Laminate, the use of an ink-jet receptive fragile beadbond layer such as that described in U.S. Pat. Nos. 6,136,890, 6,022,403 and 5,951,749 (Kuo et al) would allow the data to be printed directly onto the fragile layer. In one aspect of this embodiment, ink-jet printing can be used to personalize the document by printing directly on the exposed surface of this fragile construction, either before or after the durable layer is laminated to the fragile layer. The method of personalizing and creating this type of data sheet can include pre-attaching the unprinted transparent data sheet that includes the durable and ink-receptive fragile layers into a document, such as a passport book. The personalization data can then be printed on the exposed surface of the fragile layer. If, subsequently, someone attempted to tamper or alter the personalization data or separate the fragile and durable layers, the fragile layer would indicate tampering.

### Durable Layers

The term “durable” layer, as used herein, describes a film that is a free-standing film, without the necessity of a carrier layer that can survive document-making process steps, such as being sewn into the spine of a passport book, as well as repeated handling, such as typical passport use. It is advantageous that the durable layer be thermally stable to withstand laminating or other processing temperatures, typically in the range of 100 to 150° C.

When the durable layer is a thermoplastic film, it preferably is a polyester such as polyethylene terephthalate, as such films are typically scratch-resistant and have good transparency and good dimensional stability over a wide range of temperatures. Other useful simple thermoplastic films include polycarbonates, polyimides, cellulose acetate, polyethylene naphthalate, and polypropylenes, such biaxially oriented polypropylene.

It may be desirable to include embossments on the durable layer as an additional form of security feature. Embossments would consist of relief features comprised of indicia or images that would differentiate the durable layer from commodity transparent films available from non-secure sources.

### Multilayer Optical Films

A preferred component of the present disclosure is a color shifting multilayer optical film comprising alternating layers of at least a first polymer and a second polymer; the film appearing substantially clear at approximately a zero degree observation angle, and colored at least one observation angle greater than a predetermined shift angle. This film is described in U.S. Pat. No. 6,045,894 (Jonza et al.), herein incorporated by reference. The disclosure includes a multilayer optical film comprising alternating layers of at least a first polymer and a second polymer, the film transmitting substantially all incident visible light at approximately a zero degree observation angle, and transmitting substantially all visible light except a selected portion of the red light at least one observation angle greater than a predetermined shift angle. In another embodiment, the disclosure includes a multilayer film comprising alternating layers of at least a first polymer and a second polymer, the film appearing substantially clear at approximately a zero observation angle for light of either polarization state, and appearing colored for one polarization while appearing clear for the other polarization at least one observation angle greater than a predetermined shift angle. Particular advantages of the disclosure are described in greater detail below.

In simplest terms, the multilayer optical film of the present disclosure appears to be one color when viewed by an observer at a zero degree observation angle and exhibits a different color when viewed at an observation angle that is greater than a predetermined shift angle.

One such useful multilayer optical film exhibits a color shift from clear to cyan. This effect is produced by creating a multilayer optical film that includes multiple polymeric layers selected to enable the film to reflect light in the near infrared (IR) portion of the visible spectrum at zero degree observation angles, and to reflect red light at angles greater than the shift angle. Depending on the amount and range of red light that is reflected, the film appears under certain conditions to exhibit a visible color, commonly cyan. As used herein, the term “clear” means substantially transparent and substantially colorless, and the term “shift angle” means the angle (measured relative to an optical axis extending perpendicular to the film) at which the film first appears colored. An observer viewing the inventive film at approximately a zero degree observation angle sees no color associated with the film whereas an observer viewing the film at an observation angle greater than the shift angle sees a cyan-colored film.

The advantages, characteristics and manufacturing of multilayer optical films are most completely described in U.S. Pat. No. 5,882,774, which is incorporated herein by reference. The multilayer optical film is useful, for example, as highly efficient mirrors and/or polarizers, as well as providing a clear to cyan film that can be effectively used as a security element. A particularly unique characteristic of the multilayer optical film is that at least one of the materials used to fabricate the multilayer optical film has the property of stress induced birefringence, such that the index of refraction of the material is affected by the stretching process, common in film manufacture.

It is understood that it is within the bounds of this disclosure that other color shifts besides clear to cyan are available, such as green to magenta, yellow to green, and the like, as long as the definition of “transparent” is still met. Therefore, a “transparent” data sheet is not necessarily limited to a colorless, clear data sheet.

One of the advantages of using a multilayer optical film is that embossing the film generates new, unique color shifts within the regions of embossing as described in U.S. Pat. No. 6,045,894, which is incorporated herein by reference. These embossed color shifts are especially noticeable in transmitted light, emphasizing the utility of a transparent data sheet so that authentication by transmitted light is possible.

### Additional Layers

For example, a holographic layer and a multilayer optical film layer could be bonded together by a tie layer. Alternatively, a hot melt adhesive layer and a durable layer could be bonded together using a tie layer. Suitable materials for such a tie layer include primers or adhesives, as either a coating or a film, such as urethanes, olefins, vinyls, and acrylics. The tie layer may be of an appropriate thickness, and may be applied either to the fragile layer or to the durable layer, or both, prior to bonding those two layers together. Additionally, a scratch resistant layer may be used on the outer surface of either layer.

Another such layer could be a protective coating, such as fluorinated chemicals like 3M Scotchgard™ coatings from 3M Company, St. Paul, Minn. These coatings could be applied to either the durable layer and/or the fragile layer to protect the data sheet from soiling or normal use wear.

### Method of Manufacturing

One process of manufacturing the transparent data sheet of this disclosure comprises the steps of (1) printing personalization data onto a surface of a first layer and (2) laminating this first layer, printed side to the inside, to another film or layer, wherein both layers are optically transparent and one layer is more fragile than the other. The printing or imaging process is as described above and can be accomplished with either the fragile layer or the durable layer.

In an additional embodiment, a method involves the steps of (a) pre-attaching the durable layer, into a document, such as a passport book, (b) printing on the exposed surface of the fragile material surface, a reverse image of information specific to the bearer, optionally including the bearer's portrait, and (c) laminating the durable layer with the fragile layer within the passport book, thereby forming a transparent data sheet. If, subsequently, someone were to be able to delaminate the data sheet, the fragile portion of the laminate would be destroyed.

A hot lamination process can be used to “bond” or laminate the two layers together. However, other methods of laminating two layers together can be used and are known to those skilled in the art of lamination.

In still another embodiment, a process for manufacturing a transparent data sheet comprises the steps of (1) providing a printable surface of a first fragile layer, (2) providing a second layer, which is a durable layer or is a fragile layer, with the proviso that combination of the first and second layer provide a durable sheet, and (3) providing instructions for printing the personalization data and assembling the transparent data sheet.

In an additional embodiment, manufacturing a transparent data sheet can include laminating an ink jet receptive first fragile layer to a second fragile layer or to a second durable layer, wherein both layers are optically transparent. Personalization data can then be printed onto the outer surface of the first fragile layer. The printing process can be as described herein.

### Tamper Indication

Tamper indication according to the present disclosure can be demonstrated by the transparent construction. Particularly, such a transparent document allows for inspection for tampering on either or both sides (i.e., the front and reverse sides) of the data sheet of the personalization data, and adds a new level of security to prevent forgeries. The fragile layer may contain various security features as discussed herein that can be visually authenticated. Attempts to tamper with and/or alter the personalization data in the document by, for example, applying heat, cold, or solvents to the document in an effort to remove part or all of the personalization data will result in visible damage to and/or destruction of the fragile layer and/or its security features. The security features in the fragile layer may also be visibly damaged or destroyed if attempts are made to tamper with and/or alter the personalization data in the document. For example, the fragile layer, the security features in the fragile layer, and/or the personalization data will show damage by evidence of scorching, discoloration, tearing, and other physical disruption depending on the type of tampering attempted. This damage is more evident when it can be viewed from either side of the document which can be accomplished with the tamper-indicting transparent data sheet of the present disclosure.

Another form of tampering may involve the printing of false personalization data over the original data. This type of tampering is known as over-printing and usually involves a desaturation of color of the original image. A transparent data sheet would greatly reduce the ability of counterfeiters to use over-printing to manufacture counterfeit documents of value since the data can be seen from both sides of the document.

In addition to using the transparent data sheet in passports, this data sheet can be used with other documents of value, such as identification cards or labels, entry passes, ownership certificates, financial instruments, and the like.

This disclosure is further illustrated by the following examples that are not intended to limit the scope of the disclosure.

### EXAMPLES

### Example 1

A piece of transparent hologram foil, obtained from Crown Roll Leaf, Paterson, N.J., was attached to a sheet of paper carrier with a piece of pressure sensitive transfer adhesive. The 25 micron polyester liner side of the hologram foil was in contact with the pressure sensitive adhesive, and the foil and adhesive were slightly larger than a typical passport page, about 4″×5.5″. The paper carrier was A4 size.

The exposed side of the hologram foil contained an adhesive sizing applied during the usual production of holographic hot stamping foil. The exposed adhesive sizing was imaged with a passport data sheet image containing variable data, a machine-readable zone, and a personalized photo of the passport bearer. The imaging was performed using a Konica KP1040 color toner laser printer, and the image was in reverse. The paper with imaged hologram foil was removed from the printer and placed in a passport book.

The passport book had a piece of multilayer optical film with a color shift from clear to cyan sewn into the spine of the book. The 40 micron clear to cyan film had first been deeply embossed with lines or symbols, such as the seal of a country. Then 25 microns of a hot melt adhesive of ethylene acrylic acid copolymer was extruded and bonded to the clear to cyan film using UV light and heat, forming a heat activated laminate film.

The imaged side of the hologram foil on paper carrier was put in contact with the hot melt adhesive side of the clear to cyan film in the book. The book was closed and passed through a desktop hot laminator, (commercially available from TLC, Chicago, Ill.) at approximately 121° C. at the adhesive interface. The paper carrier and attached polyester liner from the hologram foil were peeled from the hologram foil, which was now adhered to the clear to cyan film. The result was a transparent data sheet with a thin fragile transparent hologram foil on one side, through which the passport data could be read, and the durable clear to cyan laminate on the other side. The security features on the data sheet were verified as authentic when tilted at an angle to view the cyan color shift and by the presence of the transparent hologram logos.

Tampering of the personalization data was attempted by heating the document to approximately 130° C. on a hot plate and peeling the fragile transparent hologram foil from the clear to cyan film. The heat and peeling visually damaged the transparent hologram foil logos and the personalization data, and the clear to cyan film became warped and curled. The tampering attempt was visible from both sides of the transparent document.

### Example 2

A piece of transparent hologram foil, obtained from Kurz Transfer Products in Charlotte, N.C., was attached to a paper premask carrier that was coated with pressure sensitive adhesive. The polyester liner side of the hologram foil was in contact with the pressure sensitive adhesive on the premask. The entire foil and premask was slightly larger than a typical passport page, about 4″×7.5″.

The exposed side of the hologram foil contained an adhesive sizing applied during the usual production of holographic hot stamping foil. The exposed adhesive sizing was imaged with a passport data sheet image containing variable data, a machine-readable zone, and a personalized photo of the passport bearer. The imaging was performed using a Hewlett Packard HP4500 color toner laser printer, and the image was in reverse. The premask carrier with imaged hologram foil was removed from the printer and placed in a passport book.

The passport book had a piece of multilayer optical film with a color shift from clear to cyan (as described in Example 1) coated with a hot melt adhesive sewn into the spine of the book.

The imaged side of the hologram foil on premask carrier was put in contact with the hot melt adhesive side of the clear to cyan film in the book. The book was closed and passed through a desk top hot laminator, (commercially available from TLC, Chicago, Ill.) at approximately 121° C. at the adhesive interface. The premask carrier and attached polyester liner from the hologram foil were peeled from the hologram foil, which was now adhered to the clear to cyan film. The result was a transparent data sheet with transparent hologram foil on one side, through which the passport data could be read, and the clear to cyan film on the other side. The security features on the data sheet were verified as authentic when tilted at an angle to view the cyan color shift and by the presence of the transparent hologram logos.

Tampering of the personalization data was attempted by heating the document to approximately 130° C. on a hot plate and peeling the fragile transparent hologram foil from the clear to cyan film. The heat and peeling visually damaged the transparent hologram foil logos and the personalization data, and the clear to cyan film became warped and curled. The tampering attempt was visible from both sides of the transparent document.

### Example 3

A piece of 3M™ Confirm™ Security Laminate (commercially available from 3M Company, St. Paul, Minn.), was attached to a piece of paper with a pressure sensitive adhesive. The paper bead carrier side of the Confirm™ Laminate was in contact with the pressure sensitive adhesive, the Confirm™ Laminate and adhesive being the size of a passport page, about 3.5×5″. The Confirm™ Laminate was imaged using an HP4500 color toner laser printer. The image contained variable data, a machine-readable zone, and a personalized photo of the passport bearer. The image was in reverse. The paper with the imaged Confirm™ Laminate was removed from the printer and placed in a passport book.

The passport book had a piece of multilayer optical film with a color shift from clear to cyan (as described in Example 1) sewn into the spine of the book. The imaged side of the Confirm™ Laminate on the premask carrier was put in contact with the hot melt adhesive side of the clear to cyan film in the book. The book was closed and passed through a desktop hot laminator, at approximately 121° C. at the adhesive interface. The paper and attached bead carrier were peeled from the Confirm™ Laminate, which was now adhered to the clear to cyan film. The result was a transparent data sheet with Confirm™ Laminate on one side, through which the passport data could be read, and the clear to cyan film on the other side. The security features on the data sheet were verified as authentic when tilted at an angle to view the cyan color shift and by the presence of the retroreflective security features in the Confirm™ Laminate when viewed under retroreflective lighting

Tampering of the personalization data was attempted by heating the document to approximately 130° C. on a hot plate and peeling the fragile Confirm™ Laminate from the clear to cyan film. The heat and peeling visually damaged the Confirm™ Laminate and the personalization data, and the clear to cyan film became warped and curled. The tampering attempt was visible from both sides of the transparent document. In addition, damage was also visible in the Confirm™ Laminate when viewed under retroreflective lighting.

### Example 4

A piece of transparent hologram foil, obtained from Kurz Transfer Products in Charlotte, N.C., was attached to a paper premask carrier which was coated with pressure sensitive adhesive as described in Example 2. The polyester liner side of the hologram foil was in contact with the pressure sensitive adhesive on the premask. The entire foil and premask was slightly larger than a typical passport page, about 4″×7.5″.

The exposed side of the hologram foil contained an adhesive sizing applied during the usual production of holographic hot stamping foil. The exposed adhesive sizing was imaged with a passport data sheet image containing variable data, a machine-readable zone, and a personalized photo of the passport bearer. The imaging was performed using a Hewlett Packard HP4500 color toner laser printer, and the image was in reverse. The premask carrier with imaged hologram foil was removed from the printer and placed in a passport book containing a sewn-in Confirm™ Laminate on a paper liner bead carrier. The imaged side of the hologram foil on the premask carrier was put in contact with the hot melt adhesive side of the Confirm™ Laminate in the book. The book was closed and passed through a desktop hot laminator, at approximately 250° F. at the adhesive interface.

The premask carrier and attached polyester liner from the hologram foil were peeled from the hologram foil, which was now adhered to the Confirm™ Laminate. Then the paper bead carrier on the Confirm™ Laminate was peeled off, resulting in a transparent data sheet with a transparent hologram foil on one side, through which the passport data could be read, and the Confirm™ Security Laminate on the other side. The security features on the data sheet were verified as authentic by the presence of the retroreflective security features in Confirm™ Laminate when viewed under retroreflective lighting and by the presence of the transparent hologram logos. It is suggested that the sewn-in edge of Confirm™ Laminate be attached in the passport book with a narrow piece of oriented polyester film with hot melt adhesive, such that the supported edge would be more robust, particularly at the sewn-in edge

Tampering of the personalization data was attempted by heating the document to approximately 130° C. on a hot plate and peeling the fragile transparent hologram foil from the fragile Confirm™ Laminate. The heat and peeling visually damaged the transparent hologram foil, the Confirm™ Laminate, and the personalization data. The tampering attempt was visible from both sides of the transparent document. In addition, damage was also visible in the Confirm™ Laminate when viewed under retroreflective lighting.

### Example 5

A piece of transparent hologram foil (Kurz Transfer Products, Charlotte, N.C.) was attached to a paper pre-mask (as described in previous examples). The exposed side of the hologram foil contained an adhesive sizing applied during the usual production of holographic hot stamping foil. The exposed adhesive side was imaged in reverse with variable data, machine readable zone, and a photograph using a HP 4500 color toner laser printer. The imaged foil was transferred directly to a polarizer multilayer optical film (commercially available from 3M Company St. Paul, Minn.), previously sewn into the spine of a passport book, by a hot lamination process at 135° C. When the paper premask was peeled away, the imaged hologram foil was transferred intact to the polarizer multilayer optical film, which did not contain an adhesive layer. The article resulting from the above process was a transparent data sheet. The verification of the transparent data sheet was carried out as follows:

The holographic elements, the photograph and other relevant data appeared on the front side of the transparent page and the multilayer optical film underneath was essentially transparent, though with a grey mirror effect. The data sheet was then turned over along the spine of the passport to view the reverse side of the image and an additional polarizer film, such as a polarizer multilayer optical film (commercially available from 3M Company, St. Paul, Minn.) or a standard dichroic polarizer sheet was used as a verifying device. When the verifying polarizer was rotated until it crossed the polarizer with holographic images, the data on the transparent data sheet was substantially blocked out by the high reflectivity of the two crossed polarizer films, and the holographic images were visible. When the polarizer was rotated at 90 degrees to be parallel to the polarizer laminate, the data was again visible and the holographic images were only faintly visible. Thus, the authenticity of the passport could be verified by immigration and other governmental authorities.

Since the transparent data sheet contained a polarizer film, printed information on an adjacent passport page (for example, coat of arms etc.) was invisible when viewed through a verifying polarizer as described above through the front side of the data sheet. The authenticity of this page could also be verified using an electronic passport verification device such as Borderguard™ (available from Imaging Automation, Bedford, N.H.) with a polarized light source.

Tampering of the personalization data was attempted by heating the document to approximately 130° C. on a hot plate and peeling the fragile transparent hologram foil from the polarizer film. The heat and peeling visually damaged the transparent hologram foil logos and the personalization data, and the polarizer film became warped and curled. The tampering attempt was visible from both sides of the transparent document.

### Example 6

Latent Image Technology Ltd. (Israel) has developed a Latent Image Technology where the latent images are embedded in a variety of materials based on the radiation chemistry of polymers (U.S. Pat. No. 6,124,970). Utilizing this technology, LIT has the ability to create completely invisible, high-quality graphic images that remain completely invisible to the human eye, until viewed through a standard linear or circular polarizer. A sample label containing a latent image, where this label could be a standard seal of a country, etc., was obtained from LIT Ltd. and was applied to a passport page that was adjacent to a transparent data sheet that was previously sewn into the spine of the passport book. The transparent data sheet was constructed as set forth in Example 5. The datapage, in this example, in the form of a transparent polarizer multilayer optical film, was utilized to decode the latent image by bringing it in contact or close to the latent image label.

### Example 7

An ink-receptive transparent data sheet according to the present disclosure was formed with a first and second layer. The first durable layer included a 125 micron polyethylene terephthalate film coated with 50 microns of polyethylene-ethyl acrylate copolymer (manufactured by Transilwrap, Franklin Park, Ill.). The second fragile layer included an ink-receptive glass-beaded retroreflective article as described in U.S. Pat. No. 6,136,890 (Kuo). The beadbond of the second layer was composed mostly of IJ150, a fragile ink-receptive coating made by Esprix (Sarasota, Fla.). The two components were laminated together at 191° C. using a hot-can laminator with a 3″ diameter roll at a feed rate of 1 fpm.

The transparent data sheet was then imaged with floating virtual images as described in U.S. Pat. No. 6,288,842. Floating and sinking virtual images were clearly observed in reflected ambient light. These images were even more visible in transmitted light, taking advantage of the transparent nature of the data sheet.

The resulting material was then subjected to an embossing process. The embossing process used a 16″ diameter embossed roll with logos raised approximately 100 microns from the surface. The temperature of the 16″ diameter embossing roll was 121° C. while the temperature of the 16″ diameter anvil roll was 82° C. The embossing roll was in contact with the durable polyester layer, and the anvil roll was in contact with the fragile ink jet receptive layer. The embossing rate was 2 fpm with an embossing pressure of 1000 psi. The result was the presence of impressions of the logos in the durable layer side of the data sheet. Because of the compressing nature of the embossing process, a unique water marking effect was observed in the embossed regions.

An Epson Stylus C86 ink jet printer with Durabrite® inks was used to print personalization data on the outer surface of the fragile layer. The personalization data consisted of a digital picture of a face, a series of numbers on the bottom to simulate a passport machine readable zone, and various test patterns. The printing resolution and color density were similar to that of paper. Under retroreflective lighting conditions, the personalization data was only slightly visible, and the retroreflective security features were visible. The floating images were clearly seen in both ambient and retroreflected light. The personalization data could be seen from both the front and the back of the data sheet.

The transparent data sheet was sewn into a passport book as a conventional paper-based data sheet would be sewn in. The data sheet was as difficult to remove from the passport book by tearing as compared to a conventional paper data sheet. The transparent data sheet met or exceeded all passport durability requirements for normal use.

Tampering of the personalization data was attempted by heating the document on a hot plate and peeling the fragile layer from the durable polyester layer. The heat and peeling visually damaged the fragile layer and the personalization data, and the floating images were obviously damaged. The tampering attempt was easily viewed from both sides of the transparent document. In addition, damage was also visible in the ink jet receptive fragile layer when viewed under retroreflective lighting.

Tampering of the personalization data was attempted by removing ink from the fragile layer using a solvent and re-printing a portrait of someone of darker complexion. A darker complexion image was used because a lighter complexion image was unobservable. The re-printed image was somewhat obvious as a tampered document when viewed from the front side and was very obvious as a tampered document when viewed from the back side.

### Example 8

An ink-receptive transparent data sheet was made with three layers. The first layer included a 75 micron polyester film coated with 50 microns of polyethylene-ethyl acrylate copolymer (manufactured by Transilwrap, Franklin Park, Ill.). The second layer included a color-shifting (cyan to magenta) multilayer optical film coated with 50 microns of polyethylene-ethyl acrylate copolymer (manufactured by 3M, St. Paul, Minn.). The third layer included an ink-receptive glass-beaded retroreflective fragile layer from Example 7. The three layers were laminated together at 191° C. using a hot-can laminator with a 3″ diameter roll at a feed rate of 1 fpm with the multilayer optical film layer between the other two layers.

The resulting data sheet was then subjected to an embossing process. The embossing process used a 16″ diameter embossing roll with logos raised approximately 100 microns from the surface. The temperature of the 16″ diameter embossing roll was 121° C. while the temperature of the 16″ diameter anvil roll was 82° C. The embossing roll was in contact with the durable polyester layer, and the anvil roll was in contact with the fragile ink jet receptive layer. The embossing rate was 2 fpm with an embossing pressure of 1000 psi. The result was the presence of impressions of the logos in the durable layer side of the data sheet. Because of the compressing nature of the embossing process, the multilayer optical film featured different colors in the embossed regions, particularly in transmitted light.

The resulting data sheet was then printed with personalization data as in Example 7. Under retroreflective lighting conditions, the personalization data was only slightly visible, and the retroreflective security features were visible. The floating images were clearly seen in both ambient and retroreflected light. The personalization data could be seen from both the front and the back of the data sheet. When viewed from the back, the color shift of the multilayer optical film was clearly visible and striking. In particular, when viewed in transmitted light, the color shift of the multilayer optical film and its embossments provided a level of visual aesthetics and overt security that cannot be obtained with paper-based non-transparent data sheets.

Tampering of the personalization data was attempted by heating the document on a hot plate and peeling the fragile ink jet receptive layer from the durable layer composite. The heat and peeling visually damaged the fragile layer and the personalization data. The tampering attempt was easily viewed from both sides of the transparent document. In addition, damage was also visible in the ink jet receptive layer when viewed under retroreflective lighting.

Tampering of the personalization data was attempted by removing ink from the fragile layer and re-printing a portrait of someone of darker complexion. The results were the same as that observed for Example 7.

Various modifications and alterations of this disclosure will become apparent to those skilled in the art without departing from the scope and principles of this disclosure, and it should be understood that this disclosure is not to be unduly limited to the illustrative embodiments set forth hereinabove. All publications, patents, and patent applications are incorporated herein by reference to the same extent as if each individual publication or patent was specifically and individually indicated to be incorporated by reference.

What is claimed:

1. A data sheet, comprising:
a durable layer of a first material;
a fragile layer of a second material laminated to the durable layer, the first material different than the second material; and
personalization data associated with at least one of the durable layer and the fragile layer, where the durable layer and fragile layer protect the personalization data.

2. The data sheet of claim 1, where the fragile layer can further include a security feature that can be authenticated.

3. The data sheet of claim 2, where the security feature is detectably damaged after an attempt to tamper with the personalization data.

4. The data sheet of claim 1, where the fragile layer is detectably damaged after an attempt to tamper with the personalization data.

5. The data sheet of claim 1, where the personalization data can be observed from both sides of the tamper-indicting transparent data sheet.

6. The data sheet of claim 1, where the durable layer includes a security feature that can be authenticated.

7. The data sheet of claim 1, where the personalization data is printed on a surface of the fragile layer.

8. The data sheet of claim 1, where the personalization data is bonded to the fragile layer.

9. The data sheet of claim 1, including an adhesive layer between the durable layer and the fragile layer.

10. The data sheet of claim 9, where the adhesive layer includes an image positioned between the durable layer and the fragile layer.

11. The data sheet of claim 9, where the adhesive layer when re-used provides evidence of tampering.

12. The data sheet of claim 9, where the adhesive is cross-linked.

13. The data sheet of claim 1, where the second material is a glass-bead based substrate.

14. The data sheet of claim 1, where the personalization data in its entirety can be seen through one of the durable layer and the fragile layer.

15. The data sheet of claim 1, where the durable layer includes an embossment of relief features.

16. The data sheet of claim 1, where the durable layer is a multilayer optical film that undergoes a color shift.

17. The data sheet of claim 1, where the fragile layer includes an ink-receptive surface.

18. The data sheet of claim 1, further including a tie layer that bonds the durable layer and the fragile layer together.

19. The data sheet of claim 1, where the fragile layer is composed mainly of ink receptive material.

20. A data sheet, comprising:
a durable layer
a fragile layer; and
personalization data in one of the durable layer and the fragile layer, where the durable layer and the fragile layer have undergone a lamination to render the personalization data at least partially unusable when the lamination between the durable layer and the fragile layer is disturbed.

21. A data sheet, comprising:
a durable layer;
a fragile layer laminated to the durable layer;
personalization data associated with at least one of the durable layer and the fragile layer; and
a security feature associated with at least one of the durable layer and the fragile layer, where the fragile layer and the security feature are subject to detectable damaged when tampering occurs to the personalization data.
